(19) United States
(12) Patent Application Publication
(10) Pub. No.: US 2014/0317702 A1
(43) Pub. Date: Oct. 23, 2014

(54) Sharing user credentials to access services

(71) Applicants: Robbin Hughes, Plano, TX (US); Thomas O'Neill, La Jolla, CA (US); Perm Jothipragasam Kumar, San Diego, CA (US); Ramesh Rajasekaran, Chennai (IN)

(72) Inventors: Robbin Hughes, Plano, TX (US); Thomas O'Neill, La Jolla, CA (US); Perm Jothipragasam Kumar, San Diego, CA (US); Ramesh Rajasekaran, Chennai (IN)

(21) Appl. No.: 13/868,534

(22) Filed: Apr. 23, 2013

(51) Int. Cl. H04W 12/08

(52) U.S. Cl. CPC H04W 12/08
USPC 726/6

(57) ABSTRACT

A method and system to share credentials of the user automatically with the selected external wireless device in the wireless network is disclosed. The method selects the external wireless device based on the parameters and avail the services of the external wireless device in the user home wireless device. The external wireless devices are connected with a different service provider and when the user request to access the service in an external wireless device, then the method selects the optimum external wireless device among plurality of external wireless devices.

### TECHNICAL FIELD

The embodiments herein relate to wireless networks and, more particularly, to sharing credentials in wireless networks.

### BACKGROUND

Wireless networks are widely deployed to provide various types of communication services such as voice, data, and so on. Typical wireless networks may be multiple-access networks that are capable of supporting communication with multiple wireless devices by sharing available services.

Conventionally, user wants to access the services offered by other wireless device connected in the network. In this scenario, the user device request for the services offered by the other wireless device. Currently in wireless networks, home credentials and databases are owned by the user and maintained exclusively in the user's device which has been pre-programmed with its home credentials. If the user subsequently encounters a device which would be useful to work with their home credentialed device, typically manual operations have to be conducted to move credential data and various databases to/from the home device and the temporarily-useful device. A different set of manual operations has to be conducted for each different temporarily-useful device encountered.

Due to abovementioned reasons, the existing system fails to share the credentials from the user device to the temporary device automatically. There is a need for a method and system to share the credentials of the user to the newly selected device.

### BRIEF DESCRIPTION OF THE FIGURES

The embodiments herein will be better understood from the following detailed description with reference to the drawings, in which:

FIG. 1 is a wireless network that comprises a home wireless device and plurality of external wireless device, according to embodiments as disclosed herein;

FIG. 2 is an exemplary wireless network for sharing the credentials among wireless devices, according to embodiments disclosed herein;

FIG. 3 is a flow diagram explaining the process of sharing credentials with the wireless device, according to embodiments disclosed herein; and

FIG. 4 is a computing environment implementing the system of the embodiment, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

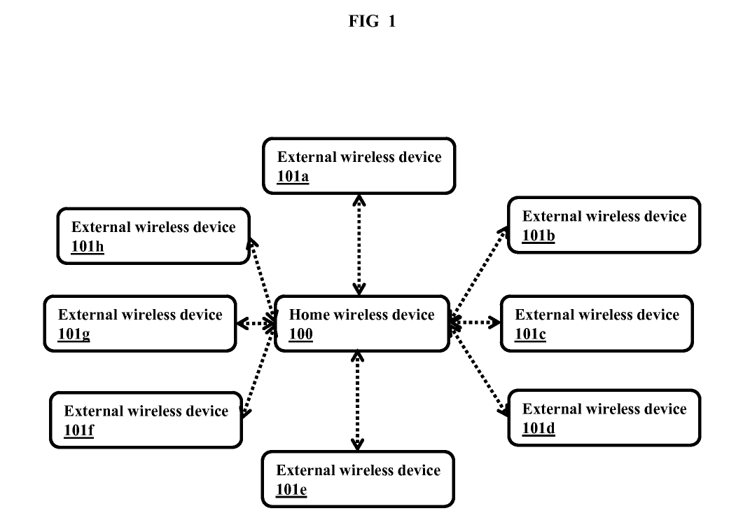

The embodiments herein disclose a method and system for sharing credentials among plurality of wireless devices in the wireless network. The method shares credentials of the user to the newly selected device to access the services offered by that new device. Referring now to the drawings, and more particularly to FIGS. 1 through 4, where similar reference characters denote corresponding features consistently throughout the figures, there are shown embodiments.

FIG. 1 is a wireless network that comprises a home wireless device and plurality of external wireless device, according to embodiments as disclosed herein. As depicted in the figure, there is plurality of external wireless devices 101a, 101b, 101c, 101d, 101e, 101f, 101g and 101h connected to a home wireless device 100.

Each external wireless device is capable of providing services with reduced cost and offers good quality. The home wireless device 100 finds the available devices around and looks out for the services offered by each external wireless device. After receiving the list of external wireless device, the home wireless device 100 selects the best external wireless device based on the parameters offered by the external wireless devices. In an embodiment, the parameters can be cost, quality, network coverage or the like.

In an embodiment, the home wireless device and the external wireless devices can be mobile phone, smart phone, laptop, desktop computer, Tablet or the like.

For example, the home wireless device 100 searches for the external wireless device that can be used to perform a video call. In this case, the home wireless device 100 encounters one or more external wireless devices to perform the video call. Then the home wireless device 100 chooses the external wireless device 101a that offers the video call with reduced cost and good quality. In other case, the home wireless device 100 may consider the external wireless device 101a based on the network coverage served by the external wireless device 101a. Then the home wireless device 100 will share the credentials required to perform the video call automatically with the selected external wireless device 101a. This does not require any user intervention

In an embodiment, the home wireless device 100 and the external wireless devices are connected in the Ad-hoc network.

In an embodiment, the Ad-hoc network can be of Wi-Fi, Bluetooth or any other wireless networks to communicate among the devices.

In an embodiment, the home wireless device 100 is capable to switch between different external wireless devices for variety of services.

In an embodiment, the credentials can be login ID, password, mobile number, e-mail ID or the like.

In an embodiment, the credentials are stored in the database such as memory of the home wireless device 100 and the system automatically share these credentials to the selected external wireless device.

The home wireless device 100 discovers the plurality of external wireless devices and performs the handshaking procedure with all the devices.

In another example, the user of the home wireless device 100 wants to download high volume of data from the internet. In that case, the user knows that his home wireless device 100 does not provide enough bandwidth to download such high volume data. In that case, there can be user interface in the home wireless device 100 for the user to search for available external devices to download high volume data with reduced cost and high quality (bandwidth). Then the user finds some external wireless devices 101b, 101c and 101d. Finally, the user chooses the external wireless device 101c since it offers 4G (fourth generation) LTE (Long Term Evolution) service to download the data at high speed. The home wireless device 100 shares the credentials of the user to the selected external wireless device 101c to start downloading the data.

In an embodiment, an application is installed in the home wireless device 100 to automatically search for available external wireless device that offers services at reduced cost and good quality and include them in the white list. Whenever, user request for services the application automatically look-out for the external wireless devices in the white list and then chooses the best devices among the devices in the white list and share credentials to the selected external wireless device.

In an embodiment, home wireless device 100 and external wireless devices are connected to different service providers. For example, the service provider can be Verizon, AT & T, Sprint, T-mobile or the like.

For example, the external wireless device 101b is connected to Verizon (4G) and the external wireless device 101c is connected to AT & T (3G) service provider. In this case, the home wireless device 100 is connected to Sprint. The home wireless device 100 is connected in 3G network of Sprint. But, the user of the home wireless device 100 wants to perform a video call in 4G network which the external wireless device 101b supports in Verizon. Thus, the application in the home wireless device 100 selects the external wireless device 101b to perform the video call in 4G network and shares the credentials of the user to the selected external wireless device 101b.

In an embodiment, all external wireless devices are pre-configured to access its services from the home wireless device 100.

In an embodiment, external wireless device is selected on-the-fly by the application installed the home wireless device 100 to access its services by the home wireless device 100.

The method and system provides for greater use of available devices which are not provisioned in the user's home wireless device 100. It also lowers the overall cost to the user of utilizing services, since more of them will be supported not just using the on-board functionality in the user home wireless device, but utilizing external wireless devices which have been determined to give lower cost and/or better performance.

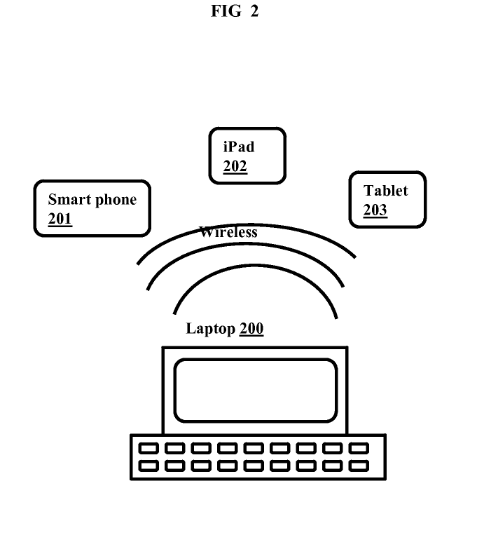

FIG. 2 is an exemplary wireless network for sharing the credentials among wireless devices, according to embodiments disclosed herein. The figure depicts a laptop 200 which is a home wireless device and a smart phone 201, iPad 202 and tablet 203 as external wireless devices. These devices are connected wirelessly. In an embodiment, the devices are connected in Wi-Fi, Bluetooth or the like. The smart phone 201 is connected to AT & T network, iPad 202 is connected to Sprint network and Tablet 203 is connected with Verizon network.

The user of the laptop 200 wants to perform a Skype call. In this case, the application in the home wireless device 100 searches for the available external devices and finds that iPad 202 which is connected in Sprint network offers less cost compared to Tablet 203 connected in Verizon network. Hence, the application selects iPad 202 and shares the user credentials with the iPad 203. After the credentials are shared, the user of the laptop 200 can perform Skype call in Sprint networks. Once the Skype call is completed the user credentials in the iPad 202 are removed.

For example, the user of the laptop wants to play a recording which is in .wma (Windows Media Audio) file format stored in the laptop memory. But, the laptop does not support the .wma format and hence the application looks for alternative device to play the recording. The application finds the smart phone, tablet which could play the recording. In that case, the application prioritizes among the smart phone, tablet and selects the optimum device to play the recording. Then the user credentials are shared to the selected device.

In an embodiment, user can also select the optimum device among the available devices to play the recording.

In this case, the features of the either the smart phone or tablet are incorporated in the laptop or finally the user can play the recording in the laptop.

In an embodiment, the user on knowing that the smart phone or Tablet can play the recording, can share the credentials with the device and use the device to play the recording.

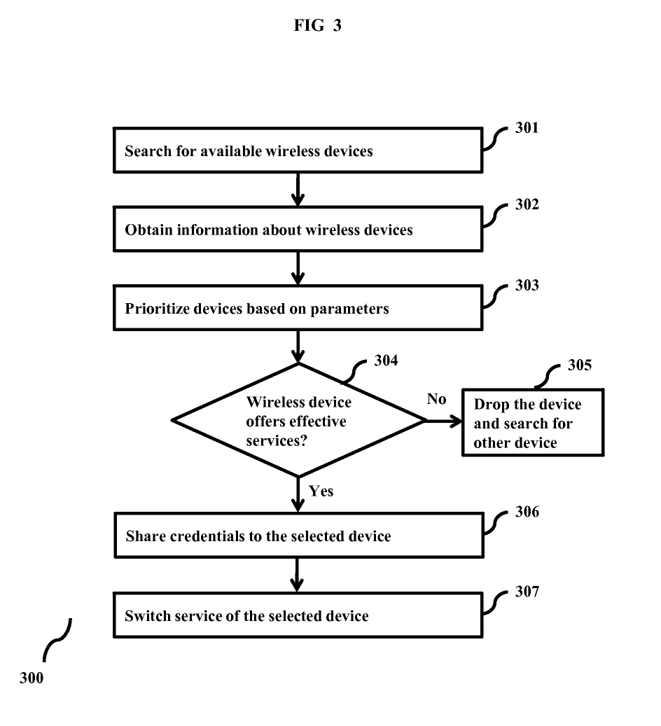

FIG. 3 is a flow diagram explaining the process of sharing credentials with the wireless device, according to embodiments disclosed herein. As depicted in the method 300, initially the method searches (301) for available external wireless devices within the environment. The process of searching comprises scanning the devices connected in the network. For example, plurality of devices is connected in Wi-Fi network. The method scans the devices in the Wi-Fi network and perform handshake with all the external wireless devices. Then the method obtains (302) the information about the external wireless devices connected in the network. In an embodiment, the information can be third-party services offered by the external wireless devices. After getting the information of each device, the method prioritizes (303) the device among external wireless devices based on parameters. In an embodiment, the parameters can be cost, quality, network coverage or the like. Further, the method checks (304) all the devices in the priority list whether the device offers cost effective services. In an example, the services can be a performing Skype call, playing music, video and so on. If the method finds that the prioritized device does not offer the cost effective services, then the method drops (305) the device and checks for other devices in the priority list. If the finds the device with cost effective services then the method shares (306) the user credentials to the selected device. Finally the method switches (307) to the service of the selected device and use those service in the home wireless device. The various actions in method 300 may be performed in the order presented, in a different order or simultaneously. Further, in some embodiments, some actions listed in FIG. 3 may be omitted.

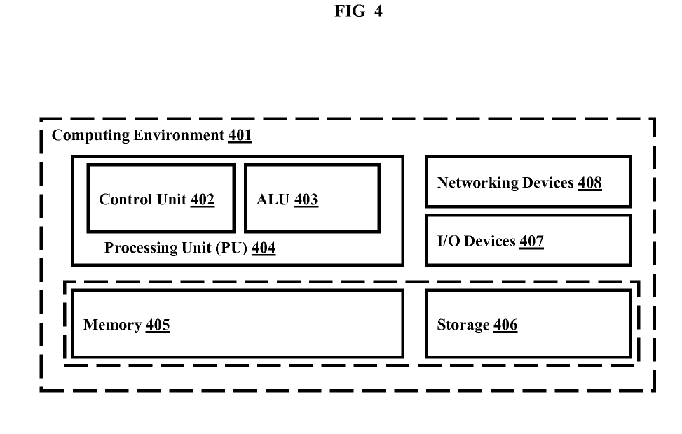

FIG. 4 is a computing environment implementing the system of the embodiment, according to embodiments as disclosed herein. As depicted the computing environment 401 comprises at least one processing unit 404 that is equipped with a control unit 402 and an Arithmetic Logic Unit (ALU) 403, a memory 405, a storage unit 406, plurality of networking devices 408 and a plurality Input output (I/O) devices 407. The processing unit 404 is responsible for processing the instructions of the algorithm. The processing unit 404 receives commands from the control unit in order to perform its processing. Further, any logical and arithmetic operations involved in the execution of the instructions are computed with the help of the ALU 403.

The overall computing environment 401 can be composed of multiple homogeneous and/or heterogeneous cores, multiple CPUs of different kinds, special media and other accelerators. The processing unit 404 is responsible for processing the instructions of the algorithm. Further, the plurality of processing units 704 may be located on a single chip or over multiple chips.

The algorithm comprising of instructions and codes required for the implementation are stored in either the memory unit 405 or the storage 406 or both. At the time of execution, the instructions may be fetched from the corresponding memory 405 and/or storage 406, and executed by the processing unit 404.

In case of any hardware implementations various networking devices 708 or external I/O devices 407 may be connected to the computing environment to support the implementation through the networking unit and the I/O device unit.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for sharing credentials among plurality of wireless devices in the wireless network. The mechanism allows identifying the external wireless device based on parameters and share the user credentials with the selected external wireless device providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for sharing user credentials automatically with an external wireless device among plurality of external wireless devices in a wireless network, wherein said method comprises:
identifying said plurality of external wireless devices in said wireless network;
determining parameters of said plurality of external wireless devices;
choosing said external wireless device among said plurality of external wireless devices based on said parameters; and
accessing at least one service in said external wireless device after sharing said user credentials with said external wireless device.

2. The method as in claim 1, wherein said method further comprising allowing said user to select said external wireless device among said plurality of external wireless devices after determining said parameters.

3. The method as in claim 1, wherein said method further comprises prioritizing said plurality of external wireless device before choosing said external wireless device.

4. The method as in claim 1, wherein said method further comprises removing said user credentials in said external wireless device when access to said at least one service is completed.

5. A system for sharing user credentials automatically with an external wireless device among plurality of external wireless devices in a wireless network, wherein said system comprises a home wireless device, said plurality of external wireless device along with:
an integrated circuit further comprising at least one processor;
at least one memory having a computer program code within said circuit;
said at least one memory and said computer program code with said at least one processor cause said system to:
identify said plurality of external wireless devices in said wireless network;
determine parameters of said plurality of external wireless devices;
choose said external wireless device among said plurality of external wireless devices based on said parameters; and
access at least one service in said external wireless device after sharing said user credentials with said external wireless device.

6. The system as in claim 5, wherein said system is configured to allow said user to select said external wireless device among said plurality of external wireless devices after determining said parameters.

7. The system as in claim 5, wherein said system is configured to prioritize said plurality of external wireless device before choosing said external wireless device.

8. The system as in claim 5, wherein said system is configured to remove said user credentials in said external wireless device when access to said at least one service is completed.

9. A computer program product for sharing user credentials automatically with an external wireless device among plurality of external wireless devices in a wireless network, wherein said product comprises:
an integrated circuit further comprising at least one processor;
at least one memory having a computer program code within said circuit;
said at least one memory and said computer program code with said at least one processor cause said product to:
identify said plurality of external wireless devices in said wireless network;
determine parameters of said plurality of external wireless devices;
choose said external wireless device among said plurality of external wireless devices based on said parameters; and
access at least one service in said external wireless device after sharing said user credentials with said external wireless device.
